(19) United States
(12) Patent Application Publication
(10) Pub. No.: US 2003/0009478 A1
(43) Pub. Date: Jan. 9, 2003

(54) Logic drawing entry apparatus

(75) Inventors: Eiji Furukawa, Kawasaki (JP); Rimi Mizuno, Kawasaki (JP); Yumi Okada, Kawasaki (JP); Keiji Itashiki, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/995,818

(22) Filed: Nov. 29, 2001

(30) Foreign Application Priority Data
Jul. 5, 2001 (JP) 2001-205190

(51) Int. Cl. G06F 7/00

(52) U.S. Cl. 707/104.1

(57) ABSTRACT

In order to edit and indicate the relations between drawings to allow easy understanding during entry of logic drawings, a logic drawing entry apparatus according to the present invention comprises a means for creating an inter-drawing connection diagram file, which describes relations of mutual connections between a plurality of drawings, and an inter-drawing connection indication means which indicates, on one screen, a plurality of the drawings outlined according to the description in the inter-drawing connection diagram file which has been created.

### FIELD OF THE INVENTION

The present invention relates to a logic drawing entry apparatus for the entry of logic drawings such as computer-aided design (CAD) drawings and, in particular, to a logic drawing entry apparatus for performing input, editing, and indication of drawings in an easy and clear way.

### BACKGROUND OF THE INVENTION

Conventional CAD applications have functions of creating and storing a plurality of drawings, retrieving requested drawings from a plurality of stored drawings and indicating the requested drawings on a screen, and modifying the names given to the drawings. For example, the invention described in the Japanese Unexamined Patent Publication No.62-256171 provides a drawing administration method of taking out hierarchic drawings efficiently. Furthermore, the invention described in the Japanese Unexamined Patent Publication No.02-100179 provides a method of making a drawing size variable and reducing the size of a circuit diagram in accordance with the drawing size.

Furthermore, the invention described in the Japanese Unexamined Patent Publication No.04-225473 provides a drawing administration method of taking out drawings relative to modified drawings automatically. Furthermore, the invention described in the Japanese Unexamined Patent Publication No.05-298378 provides a drawing administration method of identifying the relation between drawings automatically and changing the information of drawings to which modified drawings relate.

Furthermore, in the conventional CAD applications, when a move command is issued for one symbol or a plurality of symbols in one drawing, only movement or parallel movement of the symbol or a plurality of the symbols is performed, but modification of nets associated with the movement of the symbols is not performed. For example, the invention described in the Japanese Unexamined Patent Publication No.08-212369 provides a method of moving drawings, wherein when a move command is issued for one of a plurality of drawings which are arranged in a certain order, a plurality of the drawings are moved while keeping the arrangement.

Furthermore, conventionally, in case that a certain level of a hierarchy is expressed in a hierarchic design drawing, one hierarchic symbol is used. For this reason, as described in the Japanese Unexamined Patent Publication No.02-54371, in case that number of pins is limited for a hierarchic symbol, merging or division of hierarch levels is often requested.

As described above, in the conventional CAD apparatuses, a plurality of created drawings are processed individually, but new drawings clearly expressing the relation between drawings are not created. Furthermore, it is not possible to move or replace symbols in one drawing while keeping the net connection relation between symbols. Furthermore, since a symbol on a level of a hierarchy must be expressed by a single symbol, the conventional CAD apparatuses have a disadvantage such that a hierarchic symbol having many pins is inferior in legibility and an unexpected result happens in a case where the number of pins is limited.

### SUMMARY OF THE INVENTION

It is therefore an object of the present invention to provide a logic drawing entry apparatus for performing transactions between drawings, transactions about a plurality of symbols in one drawing, and so on, easily and clearly.

In order to achieve the above object, the present invention provides the following three apparatuses.

The first apparatus according to the present invention comprises a means for creating an inter-drawing connection diagram file which describes relations of mutual connections between a plurality of drawings, and an inter-drawing connection indication means which indicates, on one screen, a plurality of the drawings outlined according to the description in the inter-drawing connection diagram file which has been created.

In the first apparatus, a plurality of drawings may be outlined and arranged on one screen while keeping the relation of connection between the drawings. Thus, the relations between the drawings may be understood easily. The word “outlined” means, for example, that drawings are miniaturized, that each drawing is indicated only by its drawing frame, or the like.

The first apparatus further comprises an inter-drawing connection counting means for counting the number of connections between a plurality of drawings about symbols included in a plurality of said drawings, and a net connection relation drawing means for drawing net connection relations between the drawings based on the number of inter-drawing connections counted by said inter-drawing connection counting means.

In this apparatus, when a plurality of drawings are indicated on one screen, each connection status between the drawings may be indicated together.

The first apparatus further comprises a drawing name modifying means for modifying names of a plurality of said drawings, and a drawing name arranging means for arranging the drawings in ascending or descending order based on the modified drawing names.

In this apparatus, the names of a plurality of drawings already arranged may be modified by one operation so that intervals between the drawings are made longer or shorter. Consequently, it is easy for new drawings to be inserted between the drawings already arranged, or, that unnecessary drawings are removed. In addition, it is also possible that a plurality of drawings whose functions are similar to each other are arranged together, which fact is effective in case that functions of the drawings are determined based on the arrangement of the drawings.

The second apparatus according to the present invention is a logic drawing entry apparatus for the processing of drawings in which a plurality of symbols, and nets expressing connection relations between symbols, are indicated, the logic drawing entry apparatus comprising a symbol selecting means for selecting symbols to be moved and positions where the selected symbols are moved, a symbol moving means for moving said selected symbols to said positions, a symbol replacing means for replacing positions of said selected symbols with the positions where said selected symbols are moved when other symbols than said selected symbols exist at the positions where said selected symbols are moved, and a net redrawing means for redrawing nets for said selected symbols after the movement or replacement while keeping the connection relations between said selected symbols before the movement.

In this apparatus, movement and replacement of symbols may be performed directly while keeping a net connection relation on a drawing. In addition, it is not necessary to switch between the transaction in moving mode and the transaction in replacing mode every time movement or replacement of symbols is executed.

The second apparatus further comprises an arranging means for arranging a plurality of selected symbols on a drawing in a vertically line or a horizontally line.

In this apparatus, it is easy to move the symbol constituting a particular function to a legible position on a drawing.

The third apparatus according to the present invention is a logic drawing entry apparatus for processing of drawings in which hierarchic symbols having a plurality of pins are described, the logic drawing entry apparatus comprising a hierarchic symbol drawing means for drawing individual symbols constituting said hierarchic symbols, and a net drawing means for drawing nets for individual symbols which have been drawn.

In this apparatus, since hierarchic symbols having many pins may be separated into individual symbols to be indicated, number of pins of one symbol is decreased. Consequently, it is easy to understand descriptions in drawings. Furthermore, it may be avoided to limit the number of pins of hierarchic symbols accordingly, which fact effects allows the symbols to be used in accordance with the purpose thereof, and so on.

### BRIEF DESCRIPTION OF THE DRAWINGS

FIG. 1 is a block diagram depicting the configuration of an embodiment of a logic drawing entry apparatus according to the present invention.

FIG. 2 shows details of the inter-drawing connection diagram transaction unit shown in FIG. 1.

FIG. 3 shows details of the inter-drawing connection diagram net connection drawing unit shown in FIG. 1.

FIG. 4 shows details of the drawing name modifying/arranging unit shown in FIG. 1.

FIG. 5 shows details of the symbol moving/replacing unit in FIG. 1.

FIG. 6 shows details of the symbol arranging unit shown in FIG. 1.

FIG. 7 shows details of the multi-symbol indicating unit shown in FIG. 1.

FIG. 8 is a flow chart depicting the transaction procedure of the first embodiment of the present invention.

FIG. 9 shows an example of inter-drawing connection diagram file.

FIG. 10 is the inter-drawing connection diagram which has been drawn in accordance with the inter-drawing connection diagram file shown in FIG. 9.

FIG. 11 shows an example of a plurality of drawings whose transaction will be performed by the apparatus according to the present invention.

FIG. 12 is an inter-drawing connection diagram of the drawings shown in FIG. 11.

FIG. 13 is an inter-drawing connection diagram in which positions of drawings have been modified from the inter-drawing connection diagram shown in FIG. 12.

FIG. 14 is an inter-drawing connection diagram in which attributes of drawings have been modified from the inter-drawing connection diagram shown in FIG. 12.

FIG. 15 is a net connection diagram in which nets between drawings have been added to the inter-drawing connection diagram shown in FIG. 12.

FIG. 16 is a flow chart depicting the procedure of creating the net connection diagram shown in FIG. 15.

FIG. 17 is a flow chart depicting the details of the step S022 in the flow chart shown in FIG. 16.

FIG. 18 is a flow chart depicting the procedure for modification or rearrangement of drawing names.

FIG. 19 is a flow chart depicting the details of the step S034 in the flow chart shown in FIG. 18.

FIG. 20 shows that a symbol to be moved in the drawing A shown in FIG. 11 has been selected.

FIG. 21 shows that nets have been redrawn after the selected symbol in FIG. 20 was moved.

FIG. 22 shows that a symbol to be replaced in the drawing A shown in FIG. 11 has been selected.

FIG. 23 shows that nets have been redrawn after the selected symbol in FIG. 20 was replaced.

FIG. 24 is a flow chart depicting the procedure for movement or replacement of symbols.

FIG. 25 is an example of drawing to which rearrangement of symbols is performed.

FIG. 26 shows that symbols to be rearranged in the drawing E in FIG. 25 have been selected.

FIG. 27 shows that nets have been redrawn after the selected symbols in FIG. 20 were rearranged.

FIG. 28 is a flow chart depicting the procedure of rearrangement of symbols.

FIG. 29 shows details of the step S053 for vertical rearrangement of symbols or step S054 for horizontal rearrangement of symbols in the flow chart in FIG. 28.

FIG. 30 shows an example of drawing having a plurality of symbols on the same level of a hierarchy.

FIG. 31 shows one of the symbols in FIG. 30 with the nets connected to it.

FIG. 32 shows one of the symbols in FIG. 30 with the nets connected to it.

FIG. 33 shows one of the symbols in FIG. 30 with the nets connected to it.

FIG. 34 is a flow chart depicting the procedure for separating a hierarchic symbol consisting of a plurality of symbols, which are indicated on one drawing, on the same level of a hierarchy, into individual symbols which are indicated on different drawings.

### DESCRIPTION OF THE PREFERRED EMBODIMENTS

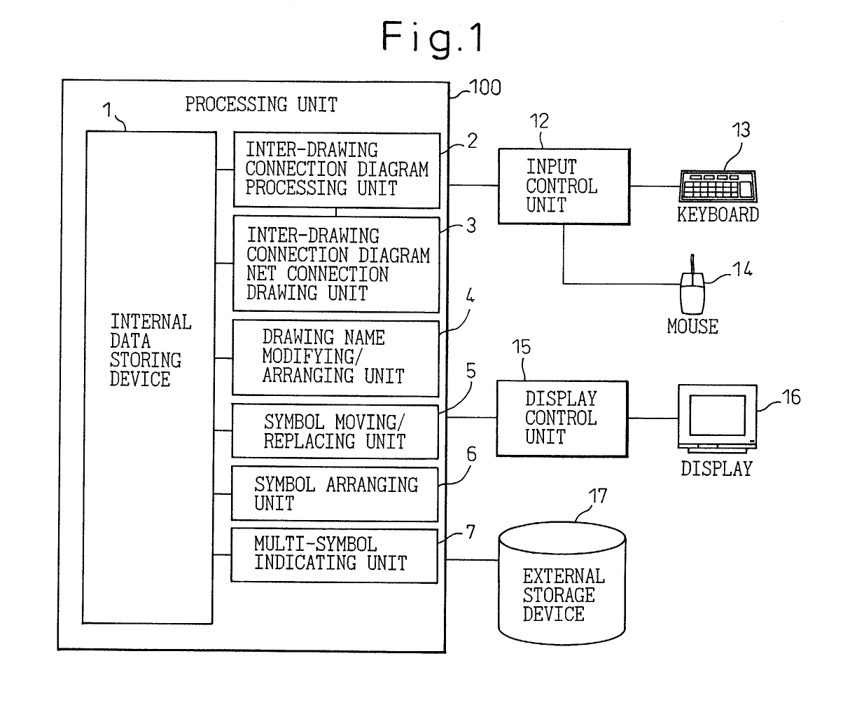

FIG. 1 is a block diagram depicting the configuration of an embodiment of a logic drawing entry apparatus according to the present invention. In this figure, the reference numeral 100 denotes the processing unit of the logic drawing entry apparatus, in which an internal data storing device 1, an inter-drawing connection diagram processing unit 2, an inter-drawing connection diagram net connection drawing unit 3, a drawing name modifying/arranging unit 4, a symbol moving/replacing unit 5, a symbol arranging unit 6, and a multi-symbol indicating unit 7 are included.

The processing unit 100 is connected to input means such as a keyboard 13 and a mouse 14 through an input control unit 12. The processing unit 100 is also connected to a display 16 through a display control unit 15. The reference numeral 17 is an external storage device.

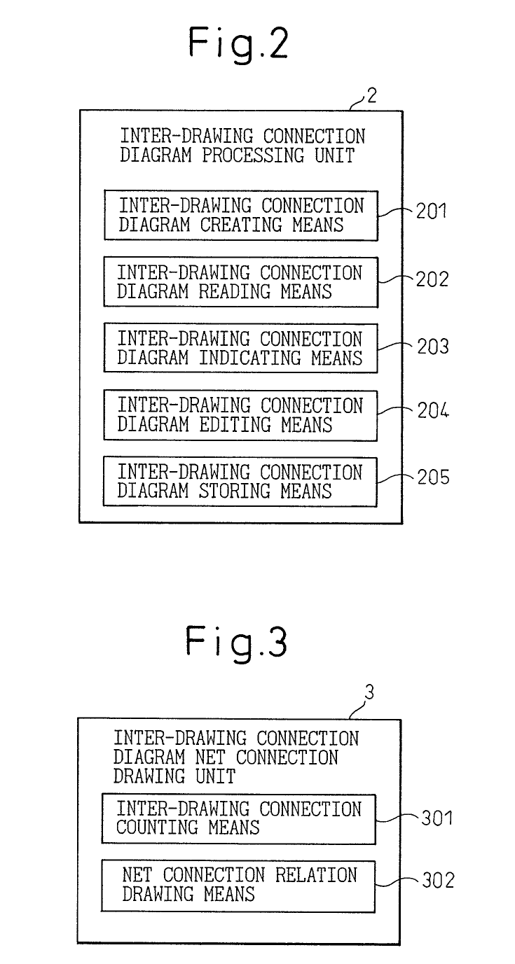

The inter-drawing connection diagram processing unit 2 in the processing unit 100 is a unit for processing inter-drawing connection diagrams, and comprises, as shown in FIG. 2, an inter-drawing connection diagram creating means 201, an inter-drawing connection diagram reading means 202, an inter-drawing connection diagram indicating means 203, an inter-drawing connection diagram editing means 204, and an inter-drawing connection diagram storing means 205.

The inter-drawing connection diagram creating means 201 creates an initial state inter-drawing connection diagram when an inter-drawing connection diagram does not exist in the external storage device 17, and then stores it in the internal data storage device 1. The inter-drawing connection diagram reading means 202 reads an inter-drawing connection diagram when it exists in the external storage device 17 and then stores it in the internal data storage device 1. The inter-drawing connection diagram indicating means 203 creates an inter-drawing connection diagram by arranging a miniature or drawing frame of each drawing on one screen according to the description in the file which is stored in the internal data storing device 1, and indicates the inter-drawing connection diagram.

The inter-drawing connection diagram editing means 204 modifies positions of, or adds attributes (color, etc.) to, drawings in an inter-drawing connection diagram which is stored in the internal data storing device 1. The inter-drawing connection diagram storing means 205 stores the inter-drawing connection diagrams which have been stored in the internal data storing device 1 into the external storage device 17.

In FIG. 1, the inter-drawing connection diagram net connection drawing unit 3 is a unit for adding net connection conditions between drawings to, and for drawing, an inter-drawing connection diagram, and comprises, as shown in FIG. 3, an inter-drawing connection counting means 301 and a net connection relation drawing means 302. The inter-drawing connection counting means 301 counts the number of pins (terminals) of the symbols in a drawing every drawing when the pins have a connection relation to pins in other drawings. The inter-drawing connection counting means 301 draws net connection relations between drawings based on the value obtained by the inter-drawing connection counting means 301. For example, the inter-drawing connection counting means 301 changes how to indicate nets according to the number of the nets.

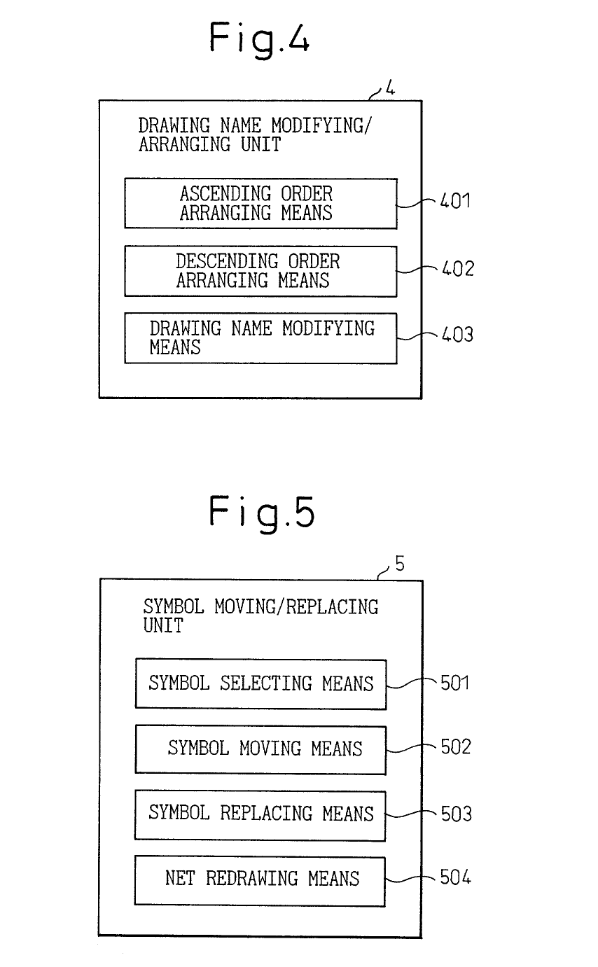

In FIG. 1, the drawing name modifying/arranging unit 4 is a unit for modifying drawing name or arranging drawings in the order of drawing name, and comprises, as shown in FIG. 4, an ascending order arranging means (a means for arranging drawings in ascending order of drawing name) 401, a descending order arranging means (a means for arranging drawings in descending order of drawing name) 402, and a drawing name modifying means 403. The ascending order arranging means 401, and the descending order arranging means 402, designate (select) a plurality of drawings, designate the name of starting drawing, designate a drawing interval, provisionally decide names of rearranged drawings, and take the provisionally decided drawing names as the real drawing names. The drawing name modifying means 403 is similar to a conventional means for modifying drawing name.

The symbol moving/replacing unit 5 in FIG. 1 is a unit for moving and/or replacing symbols, and comprises, as shown in FIG. 5, a symbol selecting means 501, a symbol moving means 502, a symbol replacing means 503, and a net redrawing means 504. The symbol selecting means 501 selects, through an input device such as a mouse 14, one of symbols on a drawing and a position where the selected symbol is to be moved. The symbol moving means 502 moves a selected symbol to another position on a drawing. The symbol replacing means 503 replaces the position of a selected symbol with the position of another symbol on a drawing. The net redrawing means 504 redraws nets which are connected with pins (terminals) of a symbol, when the position of the symbol is modified by the symbol moving means 501 or the symbol replacing means 503, while keeping the connection relation of nets before the position of the symbol is modified.

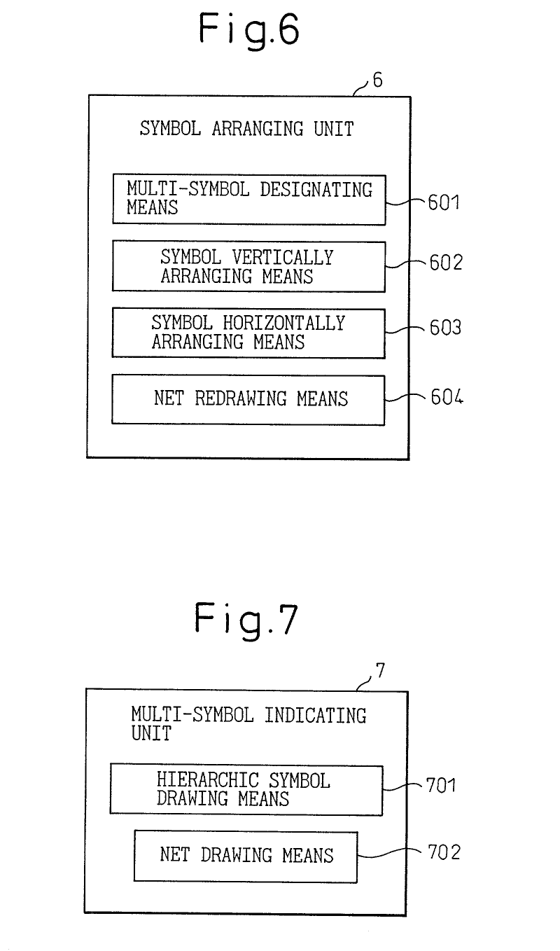

The symbol arranging unit 6 in FIG. 1 is a unit for arranging symbols, and comprises, as shown in FIG. 6, a multi-symbol designating (selecting) means 601, a symbol vertically arranging means 602, a symbol horizontally arranging means 602, and a net redrawing means 604. The multi-symbol designating means 601 selects a plurality of symbols in a drawing through an input unit such as a mouse. The symbol vertically arranging means 602 and the symbol horizontally arranging means 602 designate an interval between symbols (shorter interval, longer interval, or existing interval), designate the position of starting symbol, provisionally decide positions of rearranged symbols, and move symbols to the provisionally decided positions. The net redrawing means 604 redraws nets which are connected with pins (terminals) of a symbol, when the position of the symbol is modified, while keeping the connection relations of nets before the position of the symbol is modified.

The multi-symbol indicating unit 7 in FIG. 1 comprises, as shown in FIG. 7, a hierarchic symbol drawing means 701 and a net drawing means 702. The hierarchic symbol drawing means 701 draws a plurality of sub-symbols, one by one, which constitute a hierarchy. The net drawing means 702 draws nets which connect with pins of sub-symbols.

An embodiment of a logic drawing entry apparatus according to the present invention is configured as mentioned above and, in this embodiment, each unit in the processing unit 100 may be programmed, and thereby requested drawing processing functions may be realized.

The functions realized by the above embodiment are described below with flow charts depicting the procedure of implementing the functions.

(First Embodiment)

In the first embodiment, an inter-drawing connection diagram miniaturized in a plurality of drawings or indicated only with drawing frames is created on one screen. In order to create this diagram, the function of modifying the positions of a plurality of drawings freely on a screen, the function of adding attributes (color, etc.) to one drawing or a plurality of drawings, and the function of storing the positions and attributes of drawings are implemented.

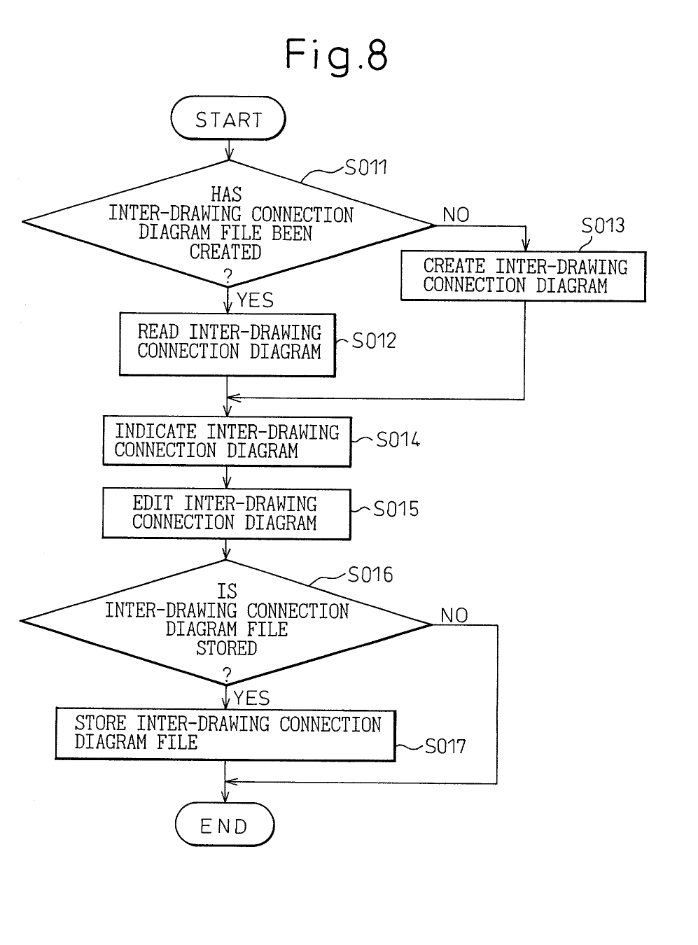

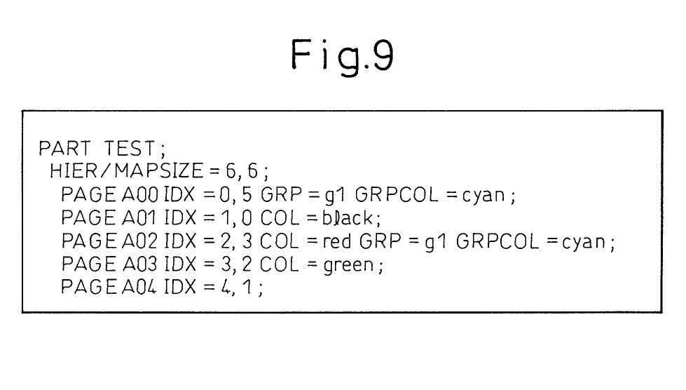

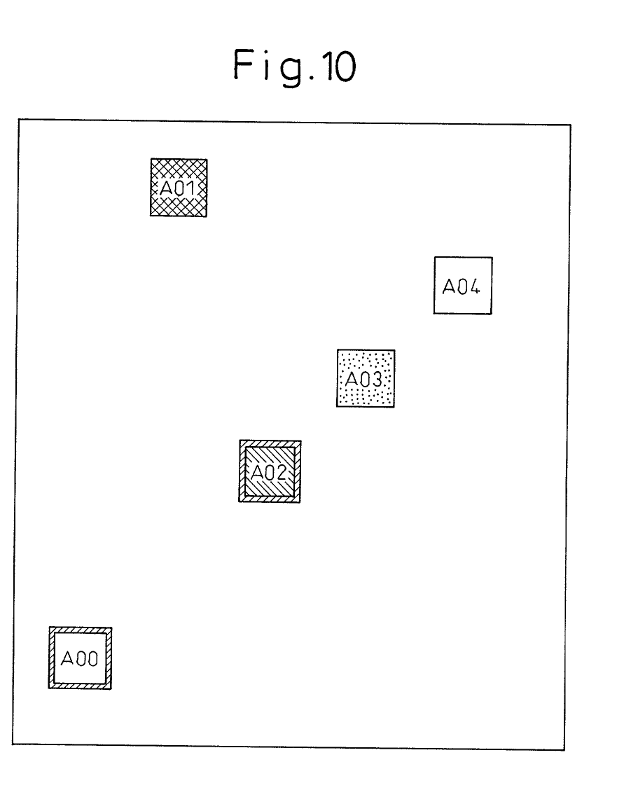

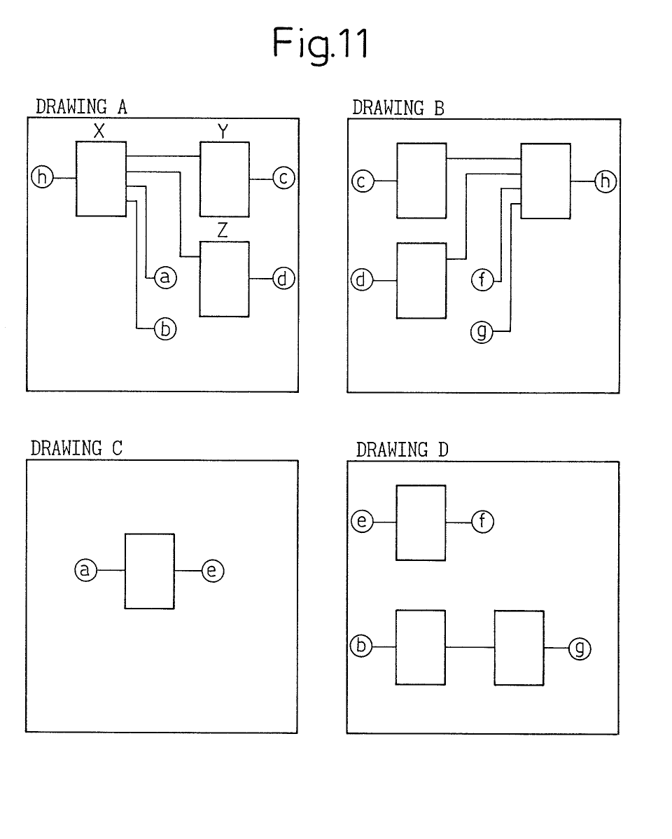

FIG. 8 is a flow chart depicting the procedure of creating an inter-drawing connection diagram. At first, it is checked whether an inter-drawing connection diagram file is stored in the external storage device 17 or not (step S011). An example of inter-drawing connection diagram file is shown in FIG. 9. The inter-drawing connection diagram created based on the contents of this file is shown in FIG. 10. In the inter-drawing connection diagram file in FIG. 9, the position of each drawing A01 to A04 on one screen and the attribute of each drawing for indication of the drawings are designated. In FIG. 10, connection relations between drawings are shown on one screen according to the designation.

When it is determined at the step S011 that an inter-drawing connection diagram file has been stored, the file is read into the internal data storage device 1 from the external storage device 17 (step S012). When it is determined at the step S011 that an inter-drawing connection diagram file has not been stored, an inter-drawing connection diagram is newly created by the inter-drawing connection diagram creating means 201 (step S013). In case that an inter-drawing connection diagram is created newly, positions of drawings are determined appropriately, and an attribute is not added.

The inter-drawing connection diagram read into the internal data storage device 1 or created newly is indicated on the display 16 by the inter-drawing connection diagram indicating means 203 (step S014). After that, the positions of the drawings are modified and attributes (color, etc.) are added the drawings by the inter-drawing connection diagram editing means 204 (step S015). When the edition is completed, the instruction of whether the created inter-drawing connection diagram is stored or not is given through the input means (step S016). If the created inter-drawing connection diagram is stored, an inter-drawing connection diagram file in which positions of the drawings and/or attributes of the drawings are described is created and stored in the external storage device 17 (step S017).

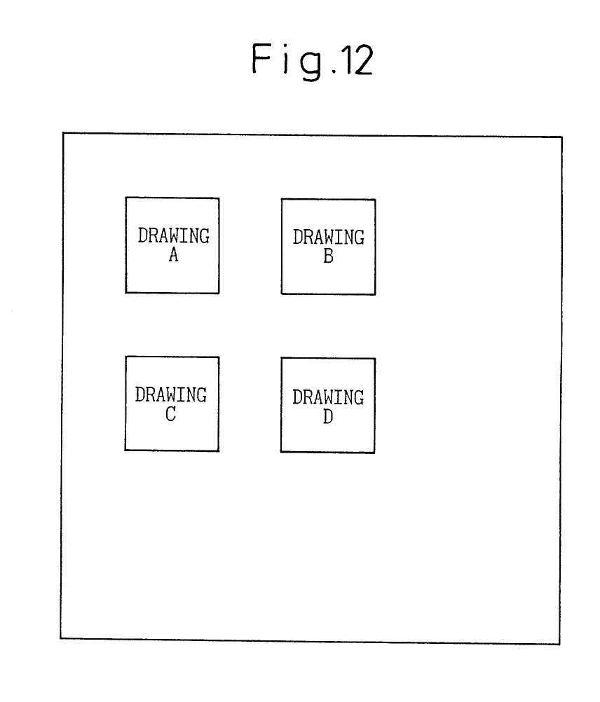

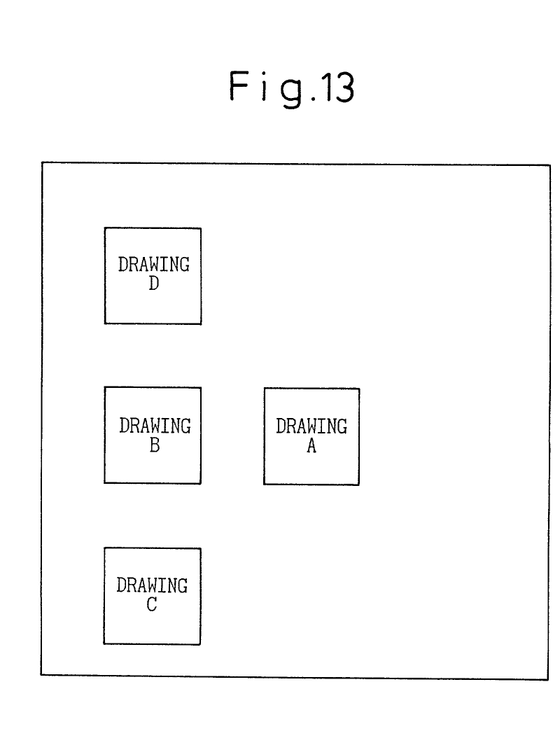

A specific example is shown below. FIG. 11 shows four drawings A, B, C, and D for which an inter-drawing connection diagram is created. FIG. 12 shows an inter-drawing connection diagram of the drawings A to D in FIG. 11, which has been created based on an inter-drawing connection diagram file stored in the external storage device 17 by the inter-drawing connection diagram creating means 201. FIG. 13 shows an inter-drawing connection diagram wherein positions of the drawings have been modified from the inter-drawing connection diagram in FIG. 12 by the inter-drawing connection diagram editing means 204.

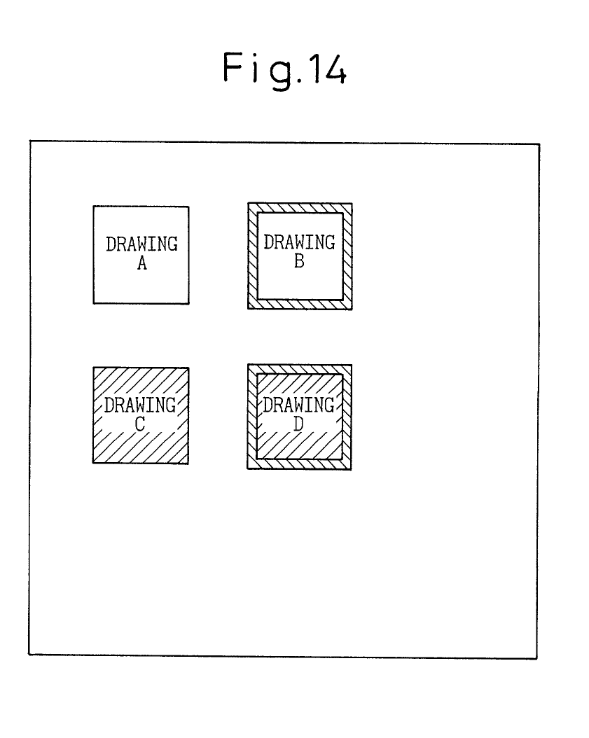

FIG. 14 shows an inter-drawing connection diagram wherein attributes have been added to the drawings of the inter-drawing connection diagram in FIG. 12 by the inter-drawing connection diagram editing means 204.

As described above, in this embodiment, it is easy that an interrelationship between drawings is indicated clearly on the display 16. The interrelationship between drawings is stored in the external storage device 17 according to the instructions of the user.

(Second Embodiment)

In the second embodiment, indication of net connection relations between drawings is added to an inter-drawing connection diagram. The “net connection relation” means a relation that shows how each pin (terminal) of symbol in each drawing is connected between drawings. A specific example about the drawings A to D in FIG. 11 is as shown below. The logic circuit in the drawing A has symbols X, Y, and Z, connection pins a, b, c, d, and h, and nets connecting the symbols. The logic circuit in the drawing B has three symbols, connection pins c, d, f, g, and h, and nets. The logic circuit in the drawing C has one symbol and connection pins a, and e. The logic circuit in the drawing D has three symbols, connection pins b, e, f, and g, and nets.

Pins with the same code are connected with each other in an actual circuit, and thus, when the drawings A and B are connected, the pins c, d, and h in the drawings A and B are connected with each other respectively. Consequently, the number of connections between the drawings A and B is three. Likewise, the number of connections between drawings A and C is one, the number of connections between drawings B and C is zero, the number of connections between drawings B and D is two, and the number of connections between drawings C and D is one.

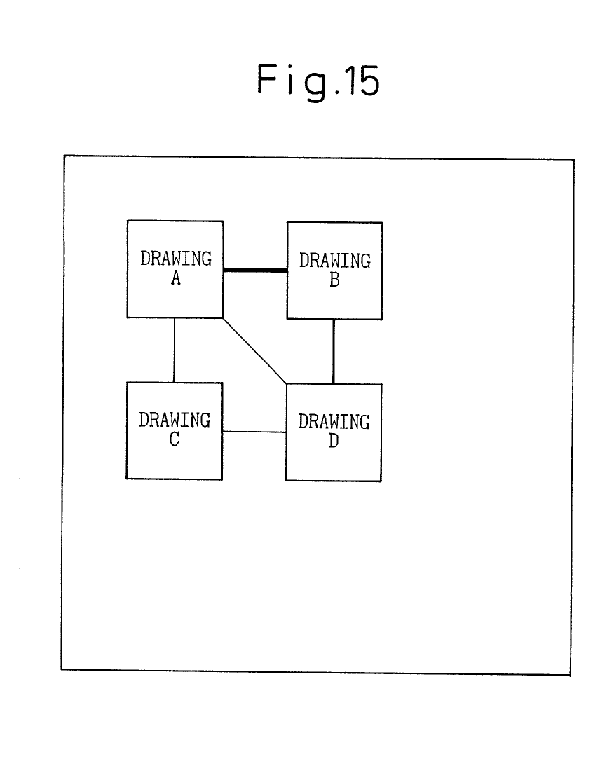

FIG. 15 shows the inter-drawing connection diagram to which numbers of inter-drawing net connections are added, and numbers of net connections are distinguished with thickness of line. That is, the thickest line means that number of connections is three, the second thickest line means that number of connections is two, and in case that number of connections is zero, any connection line is not drawn.

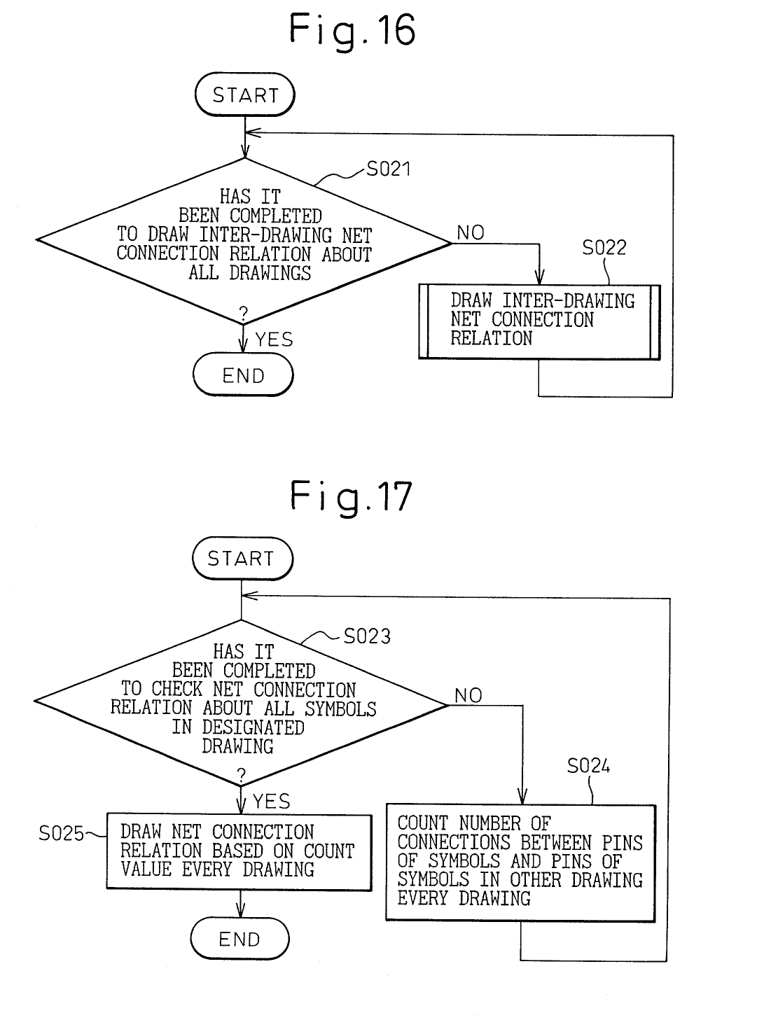

Next, the procedure of creating the net connection diagram in FIG. 15 will be described with the flow chart in FIG. 16. At first, it is checked whether net connection relations have been drawn about all drawings in the inter-drawing connection diagram (step S021). If it has not been completed yet to draw net connection relations about all drawings, inter-drawing net connection relations are drawn by the net connection relation drawing means 302 (step S022).

The procedure of the step S022 at which inter-drawing net connection relations are drawn will be described below with the flow chart in FIG. 17. At first, it is determined whether the check of net connection relations about all symbols in the concerned drawings (step S023) has been completed. If it has not been completed yet to check net connection relations about all symbols, it is investigated how the pins of symbols not been checked are connected to pins of symbols in other drawings, and the number of the connections is counted for every drawing (step S024), by the inter-drawing connection counting means 301. Next, the net connection relations are drawn in the inter-drawing connection diagram based on the counted number of connections by the net connection relation drawing means 302.

As described above, the inter-drawing connection diagram shown in FIG. 15 is created. Consequently, inter-drawing net connection relations about a plurality of drawings may be understood easily from the inter-drawing connection diagram.

(Third Embodiment)

In the third embodiment, names of drawings may be modified for a plurality of drawings to which modification of the names has been requested. In this modification, parallel movement of names, arrangement of names, arrangement of names in descending order, designation of interval of names, and so on are included.

In a conventional logic drawing entry apparatus, for example, when there are four drawings which have names 001, 002, 003, and 004 respectively and a new drawing to which the name 002 is to be given is inserted in the line of the four drawings, it is required that, at first, the name of the drawing 004 is modified to 005, and then the name of the drawing 003 is modified to 004, and then the name of the drawing 002 is modified to 003, and lastly the name 002 is given to the new drawing.

In another example, when there are four drawings which have names 001, 003, 005, and 007 respectively and the names of the drawings are modified to 001, 002, 003, and 004, it is required that the names of the drawings are modified one by one for each drawing.

On the other hand, in this embodiment, drawings having similar functions, for example, are indicated together by shifting an order of the names of drawings automatically (parallel movement) and inserting a new drawing in the line of the drawings, or by making the interval of the names of drawings shorter when the interval is long. Consequently, functions of the drawings may be assumed from the arrangement of the drawings.

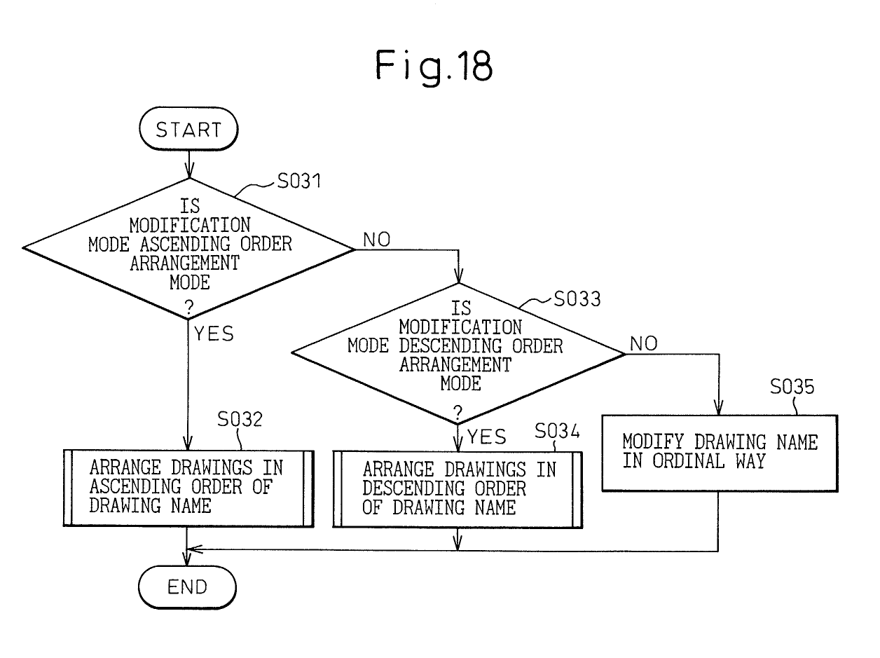

Next, the transaction procedure of this embodiment will be described with the flow chart in FIG. 18. At first, it is determined whether the designated modification mode is the ascending order arrangement mode (step S031). When the modification mode is the ascending order arrangement mode, the ascending order arrangement transaction for drawings is executed by the ascending order arranging means 401 (step S032). If the modification mode is not the ascending order arrangement mode, it is determined whether the modification mode is the descending arrangement mode (step S033). When the modification mode is the descending arrangement mode, the descending order arrangement transaction for drawings is executed by the descending order arranging means 402 (step S034).

If the modification mode is not the descending order arrangement mode, the ordinal drawing name modification transaction is executed by the drawing name modifying means 403 (step S035). The drawing name modifying means 403 is similar to the conventional drawing name modifying means.

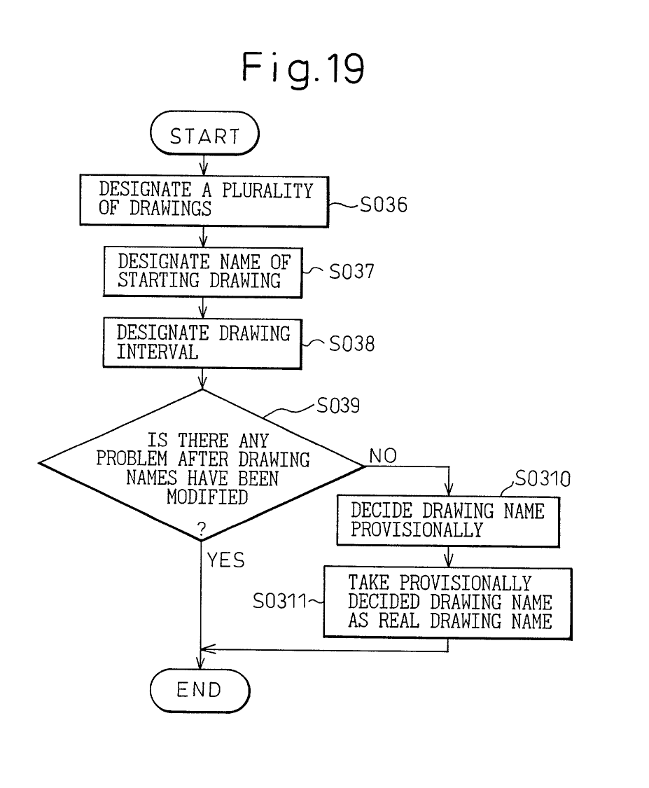

The procedures in the step S032 and S034 are described below with the flow chart in FIG. 19. The procedures in the step S032 and S034 are the same except that the step S032 is for ascending order arrangement and the step S034 is for descending order arrangement.

At first, a plurality of drawings to which the arrangement order is to be modified are designated (step S036). Next, the name of the starting drawing at the beginning of the arrangement order is designated (step S037). After that, an interval between drawings (drawing interval) is designated (step S08). When the drawing interval of 0 is designated, the drawings are rearranged without interval. When the drawing interval of 1 or more is designated, the drawings are rearranged with the designated interval. When the interval of - is designated, the drawings are rearranged with the original interval (parallel movement).

Next, after the drawings have been modified as designated at the steps S036, S037, and S038, it is checked whether there is a problem such as an overlap of drawing names (step S039). If there is no problem, a new drawing name is decided provisionally (step S0310), and then the provisionally decided drawing name is taken as the real drawing name (step S0311).

A specific example is shown below. The designated drawings are A01, A02, A04, A08, and A16. When these drawings are rearranged and the names of these drawings are modified under the condition that the drawings are arranged in ascending order of drawing name, starting drawing name is B01, and drawing interval is 0, the drawing names are modified to B01, B02, B03, B04, and B05, and the drawings are arranged in this order. Furthermore, under the condition that the drawings are arranged in ascending order of drawing name, the starting drawing name is B01, and the drawing interval is 2, the drawing names are modified to B01, B03, B05, B07, and B09, and the drawings are arranged in this order.

Furthermore, under the condition that the drawings are arranged in ascending order of drawing name, the starting drawing name is B01, and the drawing interval is -, the drawing names are modified to B01, B02, B04, B08, and B10, and the drawings are arranged in this order. Under the condition that the drawings are arranged in descending order of drawing name, the starting drawing name is B16, and the drawing interval is 0, the drawing names are modified to B16, B15, B14, B13, and B12, and the drawings are arranged in this order. Under the condition that the drawings are arranged in descending order of drawing name, the starting drawing name is B16, and the drawing interval is 2, the drawing names are modified to B16, B14, B12, B10, and B08, and the drawings are arranged in this order. Under the condition that the drawings are arranged in descending order of drawing name, the starting drawing name is B16, and the drawing interval is -, the drawing names are modified to B16, B08, B04, B02, and B01, and the drawings are arranged in this order.

As described above, in this embodiment, the names of the drawings already arranged may be modified by one operation so that intervals between the drawings are made longer. Consequently, it is easy that new drawings are inserted between the drawings already arranged, or, that unnecessary drawings are removed. Furthermore, the drawings already arranged with long intervals between drawing names may be arranged with shorter intervals between drawings. Consequently it is also possible that a plurality of drawings whose functions are similar to each other are arranged together, which fact is effective in case that functions of the drawings are determined based on the arrangement of the drawings.

(Fourth Embodiment)

In this embodiment, selected symbols on one drawing are moved, or, the selected symbols are replaced with each other. Both of the movement or replacement of selected symbols are executed in the replacement mode. That is, when a certain symbol and a position where any symbol does not exist, on a drawing, are selected, and then the replacement transaction is executed, the selected symbol may be moved to the selected position. Furthermore, when a first symbol and other symbol (second symbol) on a drawing are selected, and then the replacement transaction is executed, the first and second symbols may be replaced with each other. Furthermore, the pins of the symbols and the nets between symbols are redrawn automatically with the movement and replacement of the symbols.

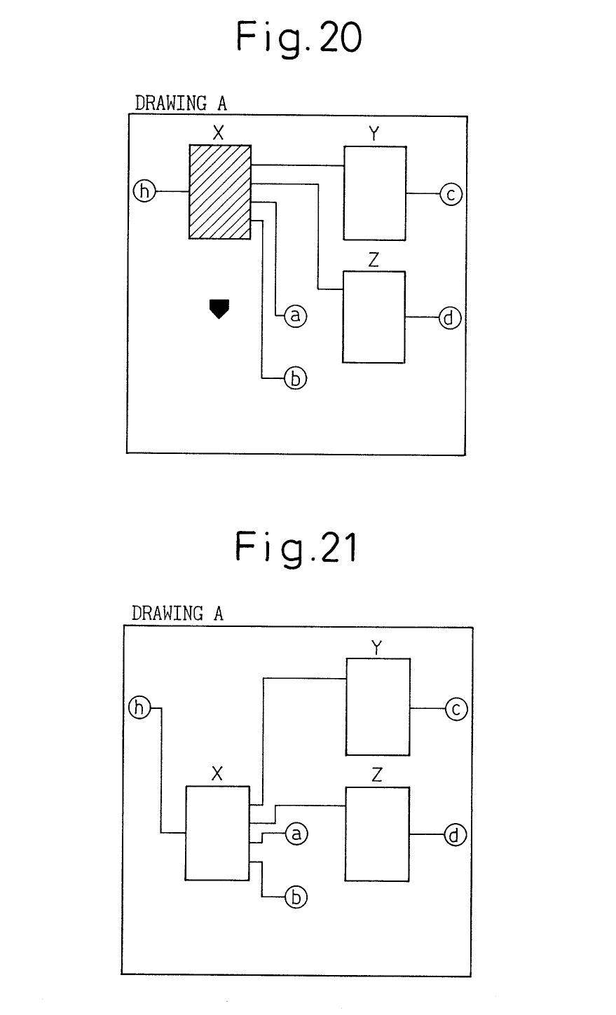

Specific examples of the transactions in this embodiment are described below with FIGS. 20 to 23. At first, symbols X, Y and Z are indicated with nets in the drawing A shown in FIG. 20. On this drawing, when the symbol X is selected at first, and then a position (marked with an arrow) where no symbol exists is selected, and then the replacement transaction is executed, the symbol is moved to the selected position as shown in FIG. 21. In this case, the pins and the nets between the symbols are redrawn while keeping the connection relation before the symbol X is moved.

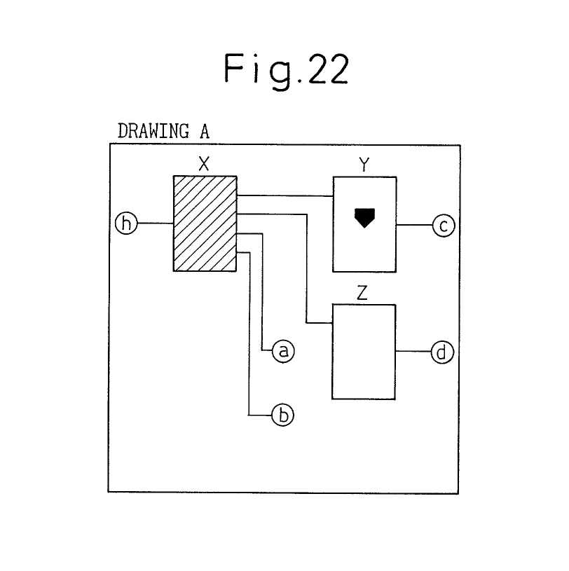

Furthermore, as shown in FIG. 22, when the symbol X is selected, and then the symbol Y (marked with an arrow) is selected, and then the replacement transaction is executed, the symbol X and the symbol Y are replaced with each other. In this case, the pins and the nets between the symbols are redrawn while keeping the connection relation before the symbol X is moved.

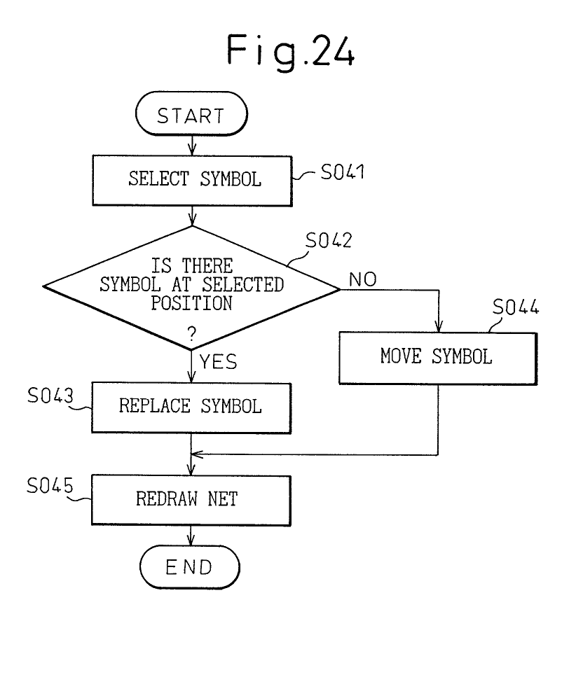

FIG. 24 is a flow chart depicting the procedure for movement or replacement of the above symbols. At first, a symbol on the drawing is selected with the symbol selecting means 501, and then a position where the symbol is to be moved is selected (step S041). After that, it is checked whether a symbol exists at the selected position or not (step S042). If a symbol exists at the selected position, the symbol is replaced with the selected symbol by the symbol replacing means 503 (step S043).

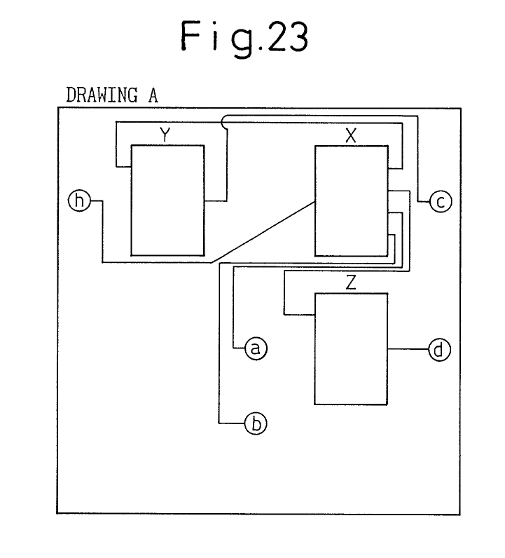

When a symbol does not exist at the selected position, the selected symbol is moved to the selected position by the symbol moving means 502 (step S044). Next, the pins and the nets are redrawn while keeping the connection relation by the net redrawing means 504. Consequently, movement or replacement of the selected symbol is executed as shown in FIG. 21 or FIG. 23.

In this embodiment, replacement of a symbol may be executed directly on a drawing. In addition, it is not necessary to switch between the transaction in moving mode and the transaction in replacing mode every time movement or replacement of a symbol is executed.

(Fifth Embodiment)

In a conventional logic drawing entry apparatus, in case that a plurality of symbols constitute a particular function, the symbols may be moved only in parallel when they are moved. Furthermore, in case that a symbol exists at any of the positions where the symbols are to be moved in parallel, the symbols can not be moved to the positions in parallel, or, the symbols are moved to the positions which are different with the intended positions. In order to move the symbols to the intended positions, the symbols need be moved one by one.

For this reason, this embodiment has realized the function that selected symbols in a plurality of symbols which have been drawn on a drawing are arranged automatically in a vertical line or a horizontal line. At the same time, intervals between symbols to be arranged may be modified or kept as existing.

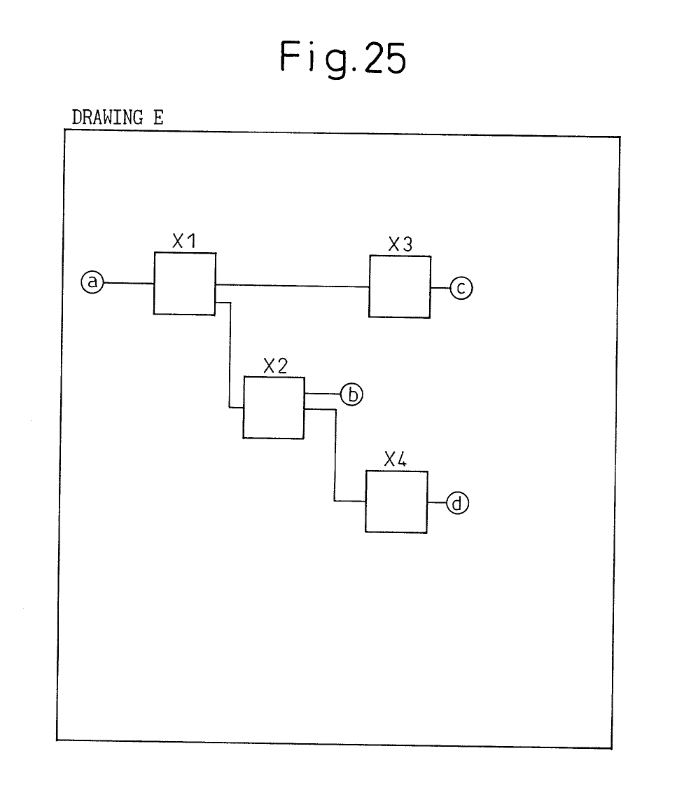

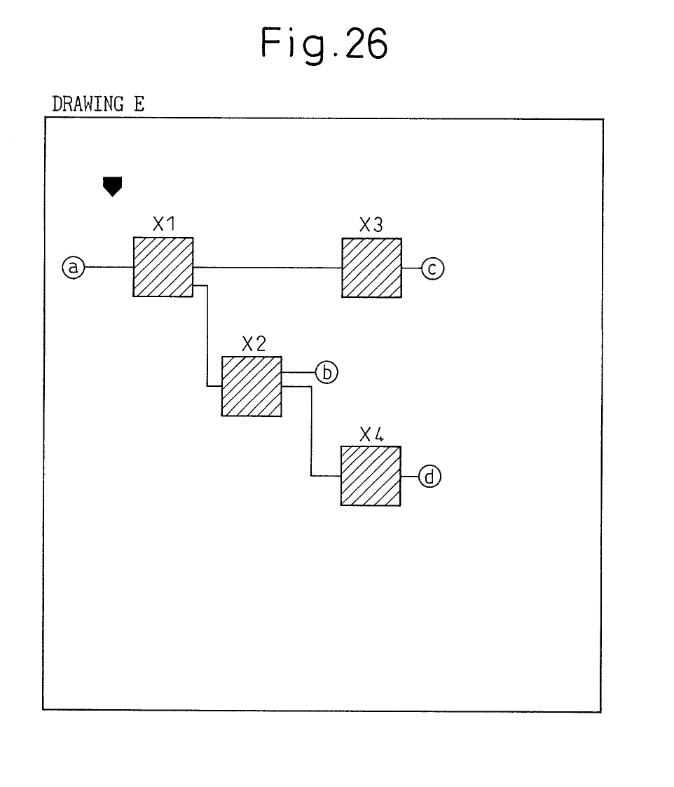

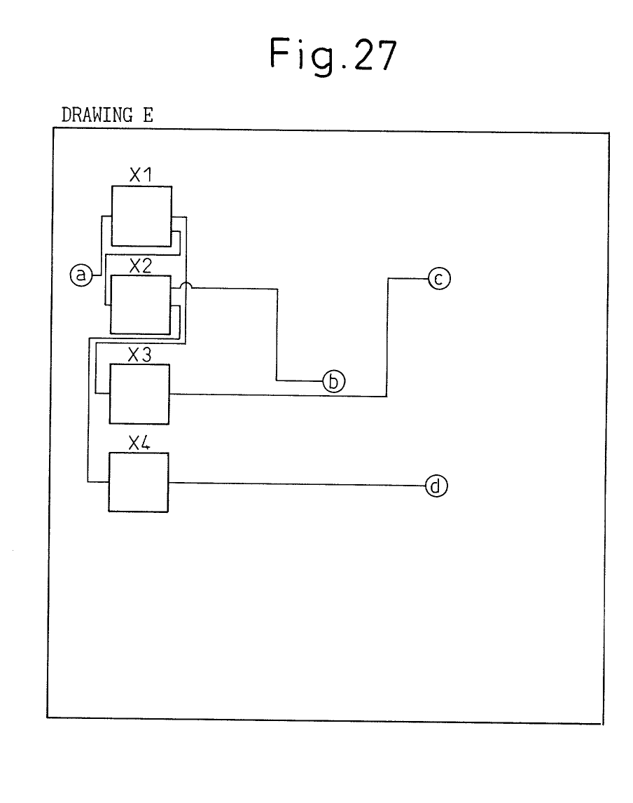

A specific example of this embodiment is shown in FIGS. 25 to 27. FIG. 25 shows a drawing E in which rearrangement of symbols is executed. In the drawing E, X1 to X4 are symbols, and a to d are symbol pins. When the symbols to be rearranged are selected as shown in FIG. 26, and then the vertical arrangement transaction is executed, the symbols X1 to X4 are rearranged in a vertical line, as shown in FIG. 27, while keeping the connection relations of pins and nets between symbols.

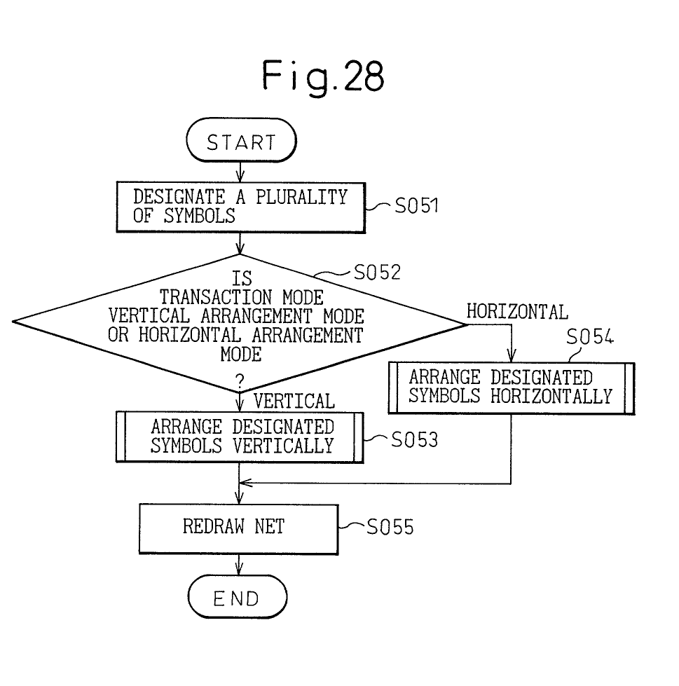

FIG. 28 is a flow chart depicting the procedure of rearrangement of symbols. At first, a plurality of symbols in a drawing are selected by the multi-symbol designating means 601 (step S051). Next, it is determined whether the designated transaction mode is the vertical arrangement mode or the horizontal arrangement mode (step S052). When the transaction mode is the vertical arrangement mode, the vertical arrangement transaction for the designated symbols is executed by the symbol vertically arranging means 602 (step S053). When the transaction mode is the horizontal arrangement mode, the horizontal arrangement transaction for the designated symbols is executed by the symbol horizontally arranging means 603 (step S054). After that, the pins and the nets are redrawn by the net redrawing means 604 (step S055).

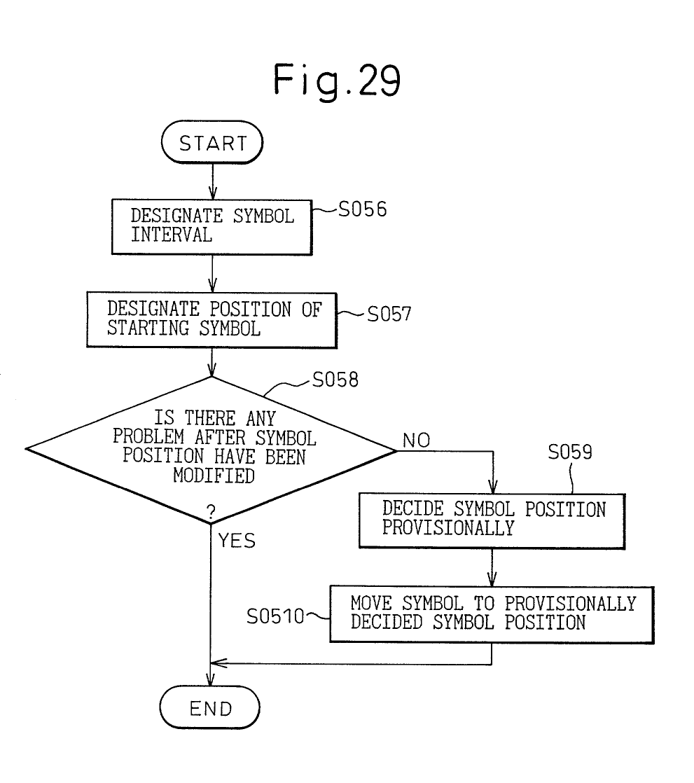

Next, the steps S053 and S054 where the selected symbols are rearranged vertically and horizontally respectively will be described with the flow chart in FIG. 29. The procedures in both steps are the same except that the step S053 is for vertical arrangement and the step S054 is for horizontal arrangement, and the common procedure is described using FIG. 29.

At first, an interval between symbols (symbol interval) is designated (step S056). When the symbol interval of 0 is designated, the symbols are rearranged without interval. When the symbol interval of 1 or more is designated, the symbols are rearranged with an interval proportional to the designated interval. When the symbol interval of - is designated, the symbols are rearranged while keeping the original vertical interval in case of vertical rearrangement, or, the original horizontal interval in case of horizontal rearrangement.

Next, a position of the starting symbol is designated (step S057). And it is checked whether there is a problem such that the symbols extend off the drawing after the symbols have been removed as designated at the steps S056 and S057 (step S058). If there is no problem, new positions of the symbols are decided provisionally (step S059), and then the symbols are moved to the provisionally decided positions (step S0510).

When the symbols are moved, if there is any symbol at a provisionally decided position, the symbols may be shifted horizontally from the provisionally decided positions in case of vertical arrangement, or may be shifted vertically from the provisionally decided positions in case of horizontal arrangement.

As described above, the transaction shown in FIG. 25 to FIG. 27, as an example, is executed. In FIG. 27, the symbol interval of 0 is selected.

In this embodiment, symbols constituting a particular function on a drawing may be moved to the positions where the symbols are clearly distinguished.

(Sixth Embodiment)

In this embodiment, in case that a logic drawing is designed hierarchically, a symbol on a level of the hierarchy may be expressed with a plurality of symbols.

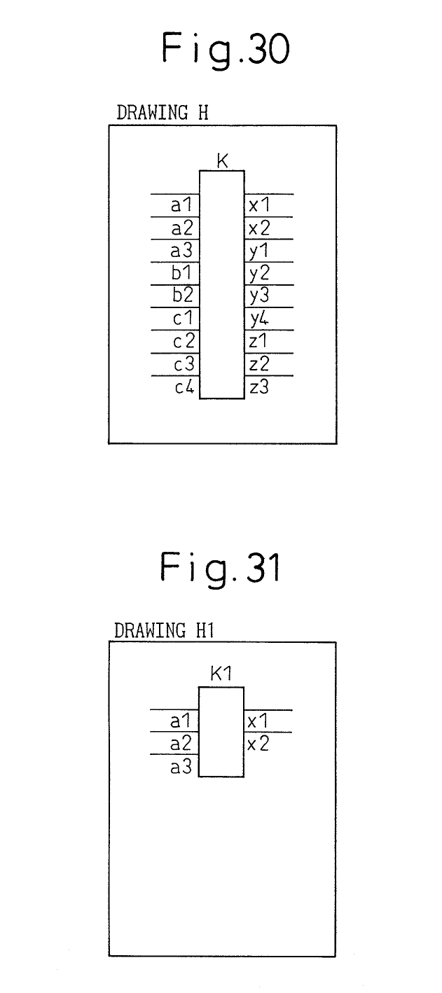

A specific example is shown below. In the drawing H shown in FIG. 30, a symbol on a level of a hierarchy has been drawn. This symbol K is a hierarchic symbol, and includes a plurality of symbols K1, K2, and K3. The symbol K1 has input pins a1 to a3 and output pins x1 and x2, the symbol K2 has input pins b1 and b2 and output pins y1 to y3, and the symbol K3 has input pins c1 to c4 and output pins z1 to z3.

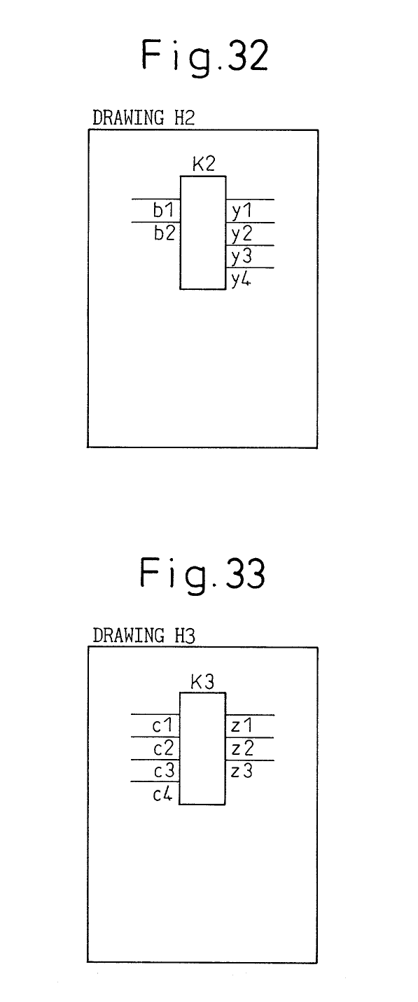

In this embodiment, these symbols K1, K2, and K3, which belong to the same level of the hierarchy, are automatically indicated on different drawings. FIGS. 31, 32 and 33 show the different drawings H1, H2 and H3 respectively.

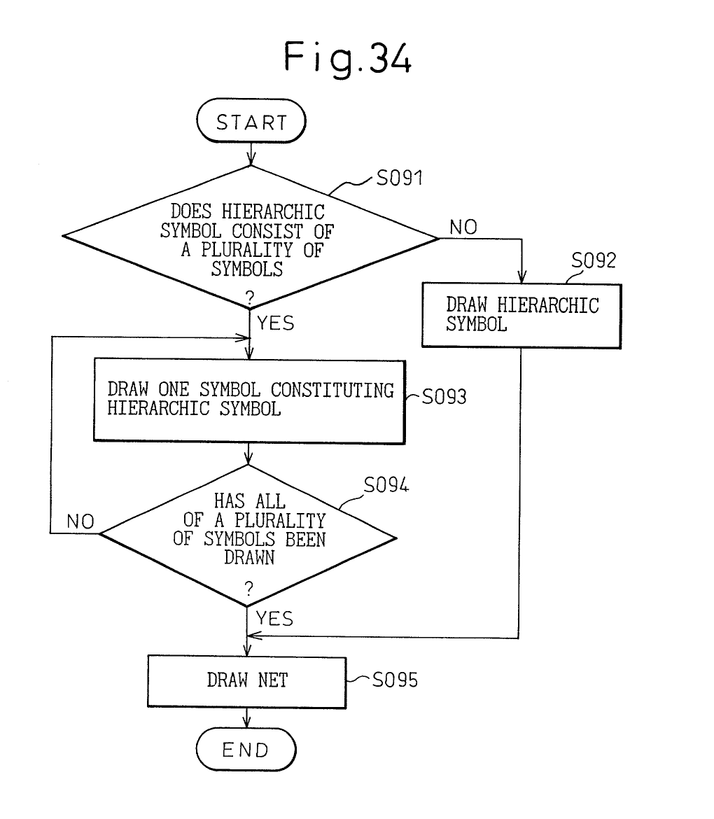

FIG. 34 is a flow chart depicting the transaction procedure of this embodiment. At first, it is determined whether the symbol K consists of a plurality of symbols or not (step S091). If the symbol K does not consist of a plurality of symbols, the symbol drawing transaction of the symbol K is executed by the hierarchic symbol drawing means 701 of the multi-symbol indicating unit 7 (step S092). If the symbol K consists of a plurality of symbols, the symbol drawing transaction is executed for one symbol constituting the hierarchic symbol K by the hierarchic symbol drawing means 701 (step S093). The transaction of the step S093 is continued until the symbol drawing transaction is executed for all of a plurality of the symbols (step S094). After that, nets are drawn by the net drawing means 702 (step S095).

As described above, the hierarchic symbol K consisting of a plurality of single symbols is separated into single symbols, and then the single symbols are automatically drawn.

[Effect of the Present Invention]

As described in the above embodiments, a logic drawing entry apparatus according to the present invention provides various kinds of editing functions which are implemented easily for logic drawings, and the logic drawings therefore may be understood easily, which fact results in an outstanding effect such that the operability of a logic input operation is improved.

What is claimed is:

1. A logic drawing entry apparatus comprising a means for creating an inter-drawing connection diagram file which describes relations of mutual connections between a plurality of drawings, and an inter-drawing connection indication means which indicates, on one screen, a plurality of the drawings outlined according to the description in the inter-drawing connection diagram file which has been created.

2. The logic drawing entry apparatus of claim 1 further comprising an inter-drawing connection diagram editing means for implementing editing works on each of a plurality of said drawings when a plurality of said drawings are indicated on one screen.

3. The logic drawing entry apparatus of claim 2, wherein said inter-drawing connection diagram editing means has a function of modifying the position of each drawing on an indication screen.

4. The logic drawing entry apparatus of claim 2, wherein said inter-drawing connection diagram editing means has a function of modifying the attributes of each drawing on an indication screen.

5. The logic drawing entry apparatus of claim 1 further comprising an inter-drawing connection counting means for counting the number of connections between a plurality of said drawings about symbols included in a plurality of said drawings, and a net connection relation drawing means for drawing net connection relations between said drawings based on the number of inter-drawing connections counted by said inter-drawing connection counting means.

6. The logic drawing entry apparatus of claim 5, wherein said net connection relation drawing means has a function of modifying the indications of the nets according to said number of inter-drawing connections.

7. The logic drawing entry apparatus of claim 1 further comprising a drawing name modifying means for modifying the names of a plurality of said drawings, and a drawing name arranging means for arranging said drawings in ascending or descending order based on the modified drawing names.

8. The logic drawing entry apparatus of claim 7, wherein said drawing name arranging means has a function of designating intervals between drawings.

9. A logic drawing entry apparatus for processing of drawings in which a plurality of symbols, and nets expressing connection relations between symbols, are indicated, the logic drawing entry apparatus comprising a symbol selecting means for selecting symbols to be moved and positions where the selected symbols are moved, a symbol moving means for moving said selected symbols to said positions, a symbol replacing means for replacing positions of said selected symbols with the positions where said selected symbols are moved when other symbols than said selected symbols exist at the positions where said selected symbols are moved, and a net redrawing means for redrawing nets for said selected symbols after the movement or replacement while keeping the connection relations between said selected symbols before the movement.

10. The logic drawing entry apparatus of claim 9 further comprising a net redrawing means for redrawing nets between symbols with the movement or replacement of symbols.

11. The logic drawing entry apparatus of claim 9 further comprising an arranging means for arranging a plurality of selected symbols on a drawing in a vertical line or a horizontal line.

12. The logic drawing entry apparatus of claim 11, wherein said arranging means has a function of designating intervals between symbols.

13. The logic drawing entry apparatus of claim 11 further comprising a net redrawing means for redrawing nets between symbols which have been rearranged while keeping the original connection relations of the nets.

14. A logic drawing entry apparatus for processing of drawings in which hierarchic symbols having a plurality of pins are described, the logic drawing entry apparatus comprising a hierarchic symbol drawing means for drawing individual symbols constituting said hierarchic symbols, and a net drawing means for drawing nets for individual symbols which have been drawn.
